(19) United States
(12) Patent Application Publication
(10) Pub. No.: US 2001/0047325 A1
(43) Pub. Date: Nov. 29, 2001

(54) Loans and lines of credit provided to terminally ill individuals

(75) Inventor: Mark Livingston, Salt Lake City, UT (US)

Correspondence Address: I. P. Docketing, PATTERSON, BELKNAP, WEBB & TYLER, 1133 Avenue of the Americas, New York, NY, 10036-6710, US

(73) Assignee: Lifewise Family Financial Security, Inc.

(21) Appl. No.: 09/794,699

(22) Filed: Feb. 27, 2001

Related U.S. Application Data
(60) Provisional application No. 60/186,733, filed on Mar. 3, 2000.

(51) Int. Cl. G06F 17/60

(52) U.S. Cl. 705/38; 705/4

(57) ABSTRACT

A method for providing lines of credit or loans to terminally ill and health-compromised individuals who have a qualified life insurance policy. The loans are secured by the policy. No scheduled payments are required, and upon death, the company collects the benefits of the life insurance policy, pays off the loan (and premiums advanced by the lender plus origination fees and accrued interest) and gives the remaining funds to the beneficiary designated by the borrower.

This application claims the benefit of Provisional Application Serial No. 60/186,733 filed Mar. 3, 2000.

This invention relates to the provision of non-recourse, life insurance asset-based consumer loan services to a large sub-set of cancer and other terminally ill patients and their families. This type of loan represents a unique source of credit-driven liquidity for terminally ill individuals and their families, provided that the cancer patient or other terminally ill individual is covered by one or more qualifying policies of life insurance.

Nearly all social workers believe that cancer patients face significant financial challenges, with three in four saying these challenges are very significant. Not only are financial pressures significant, but they are also important when compared to the other challenges cancer patients face. Over one in five social workers think that financial issues are a top priority among cancer patients. More than half report that although it is not a priority, it is an important issue nonetheless.

Actual help in the form of written information on non-government programs on financial options is lacking. There is not enough written information on private/personal financial options to provide to cancer patients and their families. They are much less likely to be knowledgeable of viatical settlements, accelerated living benefits from insurance companies, and no payment loans secured by insurance policies.

For cancer and other terminally ill patients, the loan provided in accordance with the invention represents a form of financial liquidity which may not be otherwise available. By separating the terminally ill policyholder from his or her lack of creditworthiness and underwriting (i) the medical condition of the insured to determine probable remaining life expectancy, and (ii) the credit quality of the receivable represented by the life insurance policy death benefits, it is possible to extend loans which are significant in amount, income tax neutral, preserve eligibility for means based or income-restricted financial assistance programs, entail no personal liability to repay, and require no periodic payments of principal or interest. The loans, including principal advanced (including premiums paid by the lender to continue coverage), accrued interest and origination fees, are collected out of life insurance proceeds upon death of the insured borrower. Surplus funds (excess of policy proceeds over loan pay-off) are remitted to surviving family members free from income or estate taxation. The lender is not a viatical provider but rather will be a licensed, regulated specialty consumer lender. This means the line of credit, and the subsequent loan, do not require that a borrower sell his or her insurance policy. As a result, there is no change in eligibility in state and federal means-based programs or in the income or estate tax treatment of insurance benefits.

### SUMMARY OF THE INVENTION

The loan product provided in accordance with the invention to terminally ill patients with five years or less of life expectancy and health-compromised seniors (hereinafter collectively “terminally ill patient”) is not a viatical product. It is a product, rather, for qualified terminally ill insureds, providing an open-ended line of credit established against the collateral security of their life insurance proceeds; their life insurance policies are not sold at a discount from face value, but rather are utilized as collateral for a non-recourse (no personal liability) line of credit with an established top limit borrowing amount. There are no creditworthiness standards, no payments are required, and the sole source of loan repayment is death benefit proceeds payable by the life policy insurer upon death of the insured borrower.

### BRIEF DESCRIPTION OF THE DRAWING

FIG. 1 is a flow chart showing the loan procedure according to the invention.

### DETAILED DESCRIPTION OF THE INVENTION

The invention involves a new, especially designed and implemented computer-assisted method and information data base to effectively and efficiently manage the loan application and administration functions. All loans are entered into this system and managed therefrom.

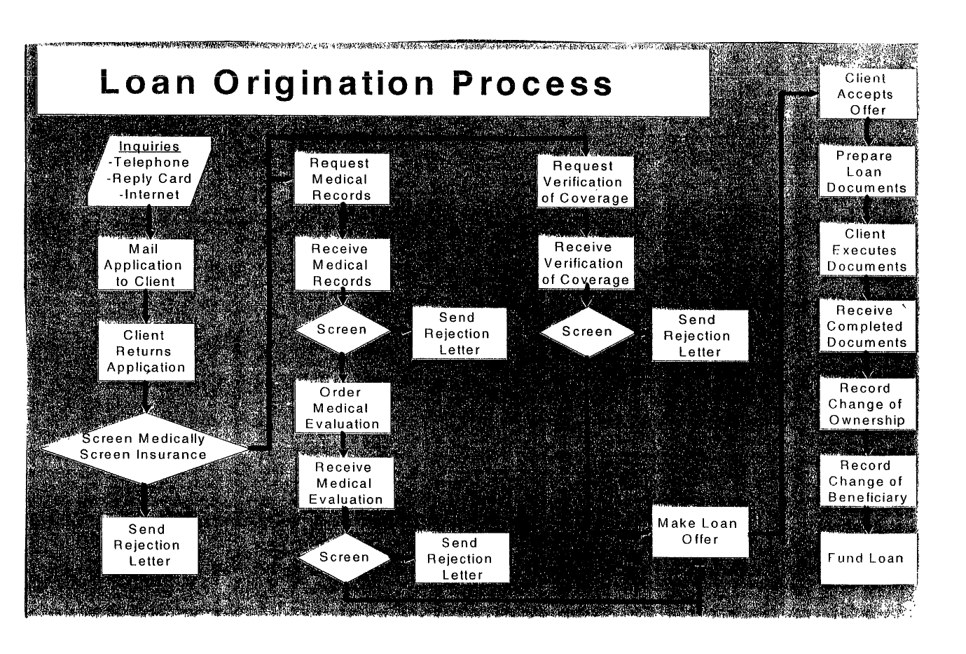

FIG. 1 illustrates a preferred embodiment of the method of the invention, showing the steps involved from inquiry to funding.

The following description is provided for conveying insight into the work-flow of the generated loans in accordance with the invention and in the application and underwriting processes of the invention as managed through this information data base. The flow chart will serve to further illustrate the method of the invention and the means for implementing it.

Once an applicant returns a completed loan application, a hard file is generated and the applicant information is entered into the client information data base.

The medical records are requested and insurance coverage verified with the policy issuer.

When the medical records are received they are forwarded to consulting physicians, who provide medical evaluation and morbidity assessments of the medical records. The assessments are then reviewed with medical consultants if necessary.

During the same period, the verification of insurance coverage responses are reviewed to verify that the policy meets the necessary criteria.

A loan offer is prepared using a loan pro forma model. The loan offer is discussed with the applicant for the loan and a hard copy is sent to him.

If the loan offer is accepted by the applicant, closing documents are prepared, reviewed and delivered to the applicant.

Once the closing documents are completed, change forms are sent to the issuer of the policy, changing the ownership and beneficiary status to the collateral agent for the lender, and copies of the closing documents are sent to the collateral agent and the applicant.

Notes are made in the applicant's file of the status of the premium payments and the due date for the next premium payment, as well as the amount of the loan and the draws against the loan.

The applicant receives the funds in the form of a cashiers' check or wire transfer.

From initial receipt of a loan application, underwriting and closing processes typically will consume two to four weeks.

All loan applications not approved are archived in accordance with applicable consumer loan regulations and management's needs.

All denied loan applicants receive a timely letter of credit denial in compliance with applicable consumer loan regulations.

Once a borrower's loan application has been processed through the stages of underwriting, a proprietary loan pro forma model is utilized which may be computer-originated to ascertain the top-end borrowing amount or credit limit which may be extended to the borrower. Model components or variables include the following: (i) amount of death benefit (policy face amount); (ii) nominal interest rate to be charged; (iii) origination fee based on the policy face amount; (iv) insurance premiums to be paid over the expected life of the insured borrower applicant; and (v) documented life expectancy.

Candidates for the loans offered are referred to the lender by agencies and organizations who are in contact with terminally ill patients, the Internet, regional treatment centers, medical collection agencies and life insurance brokerage general agencies (“BGA's”), as well as through advertising programs.

The objectives and advantages of the invention realized include for qualified terminally ill insureds, an open-ended line of credit established against the collateral security of their life insurance policy proceeds; their life insurance policies are not “sold” at a discount from face value, but rather are utilized as collateral for a non-recourse (no personal liability) line of credit with an established top limit borrowing amount. There are no creditworthiness standards, no payments are required, and the sole source of loan repayment is death benefit proceeds payable by the life policy issuer upon the death of the insured borrower.

The asset-based consumer loan structure of the loan obviates any concerns over such issues as income taxation and disqualification for means-based or income-restricted financial assistance programs.

Originally intended beneficiaries, such as family, loved ones and friends, continue to hold a residual financial interest in the life insurance policy proceeds because death benefits in excess of the amount necessary to repay the loan, including principal sums advanced, premiums advanced to continue policy coverage, interest accrued and disclosed origination fees, are remitted to the beneficiaries of the borrower, upon collection of the death benefits by the lender, in a manner free of income and estate taxation.

Once the loan is in place for a terminally ill borrower, sudden and unanticipated illness progression resulting in a materially decreased documented remaining life expectancy can be addressed through re-evaluation processes, and the line of credit borrowing limit may be increased.

The loan line of credit feature allows terminally ill borrowers, and their families, to draw down funds in increments on an as-needed basis, thereby precluding any need to deal with large sums of money in an ill-prepared or less-than-judicious manner.

Eligibility is established by underwriting the borrower's medical condition and certain collateral aspects of the pertinent life insurance policy available as security for repayment of the loan. Upon application, a request for and review of the past two years medical records of the insured will generally be carried out. The life insurance policy must be assignable and beyond contestable/suicide periods, which are typically two years from policy issue date.

The actual amount of the loan is based upon many factors, but the three most important are the face amount of life insurance coverage, projected life expectancy, and the policy premium amounts payable in the future. All factors being considered, the approximate percentage of the face amount of a policy which are provided is:

| Projected Life Expectancy | Amount |
|---|---|
| 12 months | 85% |
| 24 months | 70% |
| 36 months | 60% |
| 48 months | 50% |
| 60 months | 40% |

The invention is illustrated by but not limited to the following example.

### EXAMPLE

### The Insured

78 year old male with medical history significant for:

Medication controlled diabetes

Morbid obesity

Progressive cardiovascular disease with High Blood Pressure

Bilateral hip replacement surgery

Resolved prostate cancer 4 years prior; PSA high normal, but stable

### The Insurance Coverage

$675,000 individual policy (Renewable Term)—in place without lapse since 1981 Annual Premium Expense has increased to $3,600

Changed financial circumstances of policyholder render Annual Premium Expense unaffordable

### Loan Solution

A line of credit for the insured policyholder against the collateral security of the subject life insurance policy is arranged by the lender. Salient features of the line of credit are as follows:

Immediate lump sum borrowing availability of $136,375

Future premium payments to become due will be paid directly by the lender to the policy issuer in advance of due dates and treated as additional advances of principal for the benefit of the borrower

Non recourse (no personal liability to repay) loan; sole source of repayment of principal, interest and fees is the policy proceeds at death of insured. Insured policyholder's survival beyond predicted morbidity date does not alter or impact the borrowing except to diminish or preclude receipt of surplus funds

Receipt of $136,375 is completely income tax neutral, sums borrowed are not reportable and not included in gross income of borrower

Origination fees of $15,500 charged but funded as part of loan principal by lender once the loan offer is accepted. No out of pocket fees or expenses to establish eligibility for a line of credit and to receive a line of credit written offer

Annual nominal interest rate of 18.5% in this instance, charged on accrual basis

Absolutely no recurring payments of interest or principal owed to lender by borrowing insured policyholder

Surplus funds at death remitted to insured policyholder's family or appointees. Estimated surplus funds as time intervals projected as follows:

| Policy Collection at Time Intervals: | Projected Surplus Funds: |
|---|---|
| End of 1st Year | $490,762 |
| End of 2nd Year | $452,412 |
| End of 3rd Year | $406,967 |
| End of 4th Year | $353,115 |
| End of 5th Year | $289,301 |
| End of 6th Year | $213,680 |
| End of 7th Year | $124,070 |
| End of 8th Year | $17,882 |

At any time during term of borrowing, insured policyholder may:

Repay line of credit borrowing without penalty or premium and the lender releases assignment of the policy;

Request a medical reevaluation and provided that material adverse illness progression of a substantial accelerated nature has occurred, the lender will offer to increase borrowing amounts available under an amended credit agreement reflecting decreased remaining life expectancy.

In structuring the line of credit summarized above, the medical evaluation processes utilized by the lender have concluded that the insured policyholder will succumb not later than eight (8) years after evaluation with a high level of confidence. The greater statistical probability is that the insured will decease during years 4 or 5 when surplus funds available for remittance to the family range from $289,301 to $353,115.

Assuming that the line of credit offer is accepted and the insured policyholder borrows the full amount available ($136,375), the lender would pay to the referring BGA a referral fee of $13,500, and, upon loan maturity at the death of the insured, a net margin participation of $6,750 (provided that the loan “repaid” within a window of 2-8 years after origination). Additional referral fees would become payable if the line of credit borrowing amount is increased during its original term based upon sudden illness progression and a medical evaluation suggesting materially decreased life expectancy. It would not be necessary for the BGA or producing agent to become involved in the underwriting of the loan. The lender would be solely responsible for all aspects of medical and insurance underwriting (gathering medical records and verifying policy coverage directly with the issuer). The BGA or producing agent would merely secure the insured policyholder's signature on an abbreviated application with insurance and medical record release forms.

The same procedure would be in place and followed for all terminally ill individuals who apply for loans. A line of credit and/or loan are extended to all such individuals, with the loans being secured by the individual's life insurance policy. In most instances, the loans will be provided to terminally ill cancer patients, but it should be understood that the methods disclosed herein are applicable to all terminally ill individuals or health-compromised seniors whose life expectancy is predictable provided that the cancer or other terminally ill patient or health-compromised senior is covered by one or more qualifying policies of life insurance.

In accordance with a preferred embodiment of this invention, the lender may enter into contracts for reinsurance in accordance with which the lender is protected from a risk assumed in the practice of the invention. In other words, by reinsurance the lender contracts with third parties to transfer the whole or part of the risk assumed by it.

In accordance with another embodiment, as part of the invention, the lender may establish a securitization facility for the purpose of funding the above transactions on an ongoing basis. The creation of such a facility is believed to be the first such securitization arrangement collateralized by this type of receivable.

The invention's advantages are best achieved through the use of computer software programs designed and implemented in accordance with the invention. The software contains many custom components relating to specialized interest accrual calculations, origination fee accruals, statement generation, and monitoring of premium due upon collateralized life insurance policies in order that the collateral assets are safeguarded. Further checks and balances may be provided, manual and computer-assisted, to preserve and safeguard the collateral asset base.

I claim:

1. A method of providing a loan to a terminally-ill patient comprising the steps of:
collecting biographical and financial information about a terminally-ill patient;
collecting medical information about the terminally-ill patient;
verifying with a life insurance policy issuer details about a life insurance policy held by the terminally-ill patient, the life insurance policy having ownership and beneficiary information;
procuring from a consulting physician a medical evaluation and a morbidity assessment based on the collected medical information;
calculating terms of a loan to offer to the terminally-ill patient;
offering the loan to the terminally-ill patient; and
if the terminally-ill patient accepts the loan: preparing loan closing documents; changing the ownership information and beneficiary information of the life insurance policy and making proceeds of the loan available to the terminally-ill patient.

2. The method of claim 1 wherein the step of calculating the terms of a loan to offer to the terminally-ill patient is based on a set of variables.

3. The method of claim 2 wherein the set of variables comprises:
a face amount of the life insurance policy;
a nominal interest rate;
an amount of insurance premiums to be paid over an expected life of the terminally-ill patient; and
a life expectancy of the terminally-ill patient.

4. The method of claim 1 comprising the step of recalculating the terms of the loan based on a decreased remaining life-expectancy.

5. The method of claim 1 comprising the step of entering into contracts for reinsurance for the loan.

6. The method of claim 1 comprising the step of establishing a securitization facility to find the loan on an ongoing basis.
